(19) United States
(12) Patent Application Publication
(10) Pub. No.: US 2019/0188582 A1
(43) Pub. Date: Jun. 20, 2019

(54) COLLECTIVE DECISION MAKING BY CONSENSUS IN COGNITIVE ENVIRONMENTS

(71) Applicant: International Business Machines Corporation, Armonk, NY (US)

(72) Inventors: Jeffrey O. Kephart, Cortlandt Manor, NY (US); Nicholas Mattei, White Plains, NY (US); Francesca Rossi, Chappaqua, NY (US)

(21) Appl. No.: 15/845,509

(22) Filed: Dec. 18, 2017

(51) Int. Cl. G06N 5/04; G06N 5/02; G10L 13/04

(52) U.S. Cl. CPC G06N 5/04; G06F 17/30979; G10L 13/043; G06N 5/027

(57) ABSTRACT

Techniques are provided to automatically facilitate a decision process to enable a set of decision makers to reach a decision that represents consensus or near-consensus among the decision makers. The method comprises: obtaining input representing a set of decision alternatives and indicators of desirability corresponding to the decision alternatives; analyzing a degree of consensus among the decision makers in accordance with the desirability indicators obtained; in response to the degree of consensus being deemed sufficient, reporting the decision to the decision makers; otherwise, actively suggesting to the decision makers a set of one or more discussions in which they should engage, and for each of those discussions which decision alternatives should be discussed and which of the decision makers should participate in the discussion; and interacting with the decision makers to facilitate the discussion in order to obtain a degree of consensus that is deemed sufficient.

### FIELD

The technical field generally relates to cognitive computing environments, and more particularly to decision making in such environments.

### BACKGROUND

The process by which groups of decision makers reach a consensus is fraught with difficulties. Quite apart from the fact that people may have irreconcilable differences, the process of arriving at a final decision may: (1) be slow, occurring in fits and starts; (2) impose a high cognitive burden on the decision makers; (3) culminate in a poor decision that does not adequately represent the collective opinions of the decision makers; and (4) involve a number of constraints or the need to analyze multiple data sources. Reaching consensus has been correlated with higher decision satisfaction from decision participants compared to majority decision making.

### SUMMARY

Illustrative embodiments comprise techniques for collective decision making by consensus in a cognitive environment using a conversational agent system.

For example, in one illustrative embodiment, a method to automatically facilitate a decision process to enable a set of decision makers to reach a decision that represents consensus or near-consensus among the decision makers comprises: obtaining input representing a set of decision alternatives and indicators of desirability corresponding to the decision alternatives; analyzing a degree of consensus among the decision makers in accordance with the desirability indicators obtained; in response to the degree of consensus being deemed sufficient, reporting the decision to the decision makers; otherwise, actively suggesting to the decision makers a set of one or more discussions in which they should engage, and for each of those discussions which decision alternatives should be discussed and which of the decision makers should participate in the discussion; and interacting with the decision makers to facilitate the discussion in order to obtain a degree of consensus that is deemed sufficient.

Advantageously, in illustrative embodiments, the method is performed by a conversational agent system that facilitates group consensus without the need for a human facilitator, thereby making the process much less expensive, and available for a much broader class of decisions.

### BRIEF DESCRIPTION OF THE DRAWINGS

FIG. 1 depicts a block diagram illustrating a conversational agent system environment, according to an illustrative embodiment.

FIG. 2 depicts a block diagram illustrating a conversational agent system, according to an illustrative embodiment.

FIG. 3 depicts a flow diagram illustrating collective decision making by consensus in a cognitive environment, according to an illustrative embodiment.

FIG. 4 depicts a computer system in accordance with which one or more components/steps of techniques of the invention may be implemented, according to an illustrative embodiment.

FIG. 5 depicts a cloud computing environment, according to an illustrative embodiment.

FIG. 6 depicts abstraction model layers, according to an illustrative embodiment.

### DETAILED DESCRIPTION

Illustrative embodiments will be described herein with reference to exemplary information processing systems and associated host devices, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of computer systems or processing systems comprising various combinations of physical and virtual computing resources.

As mentioned above, illustrative embodiments provide a proactive conversational agent system that enables group consensus without the need for a human facilitator. Compared with non-facilitated group decision-making, the proactive conversational agent system reduces the cognitive burden of the participants, reduces the time required to make a decision, and improves the overall quality of the result. As will be further explained in detail, the conversational agent system helps a group of n decision makers rank m alternatives by proactively engaging the users in a conversation to refine their preferences over the set of alternatives and finally get to a consensus decision.

More particularly, the conversational agent system iteratively: (i) identifies the points of disagreement among the decision makers including which alternative(s) are causing disagreement and which decision makers are in disagreement with each other; (ii) facilitates discussion to decrease disagreement and refine preferences by: asking groups of decision makers (possibly the whole group) to think about and discuss alternatives for which they have disagreement; asking the decision makers involved in the discussion for their refined preferences; providing relevant information either proactively or on demand; and requesting clarifications or additional information from the decision makers. Once the disagreement between the input rankings has decreased sufficiently, the agent system reports the refined preferences and the consensus decision.

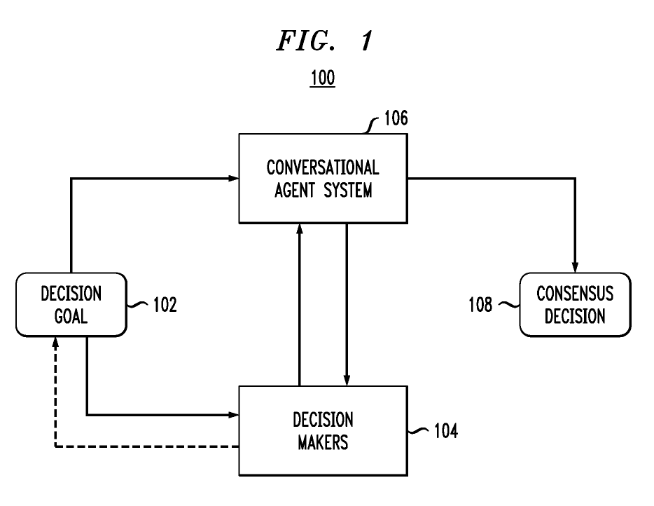

FIG. 1 depicts a block diagram illustrating a conversational agent system environment 100, according to an illustrative embodiment. As shown, a decision goal 102 is presented to a set of decision makers 104 and a conversational agent system 106. The decision makers 104 may possibly have generated the decision goal 102. In illustrative embodiments, the decision makers 104 may comprise a plurality of individuals and/or other computing systems. The set of decision makers 104 and the conversational agent system 106 iteratively interact in conjunction with the decision goal 102 to reach a consensus decision 108.

The conversational agent system 106 goes beyond a mere one-shot aggregation of the preferences of multiple decision makers, and instead actively helps them reach a consensus by: (i) highlighting subsets of alternatives that are most responsible for disagreement; (ii) partitioning the decision makers into groups that should hold a focused discussion on specific subsets of alternatives including features of the alternatives; and (iii) facilitating discussion and providing a structured methodology to move closer to consensus.

More particularly, the conversational agent system 106 proactively drives an iterative consensus process by engaging directly with human decision makers in ways that mimic what a human facilitator would do, intervening to focus the attention of the human participants on the issues that would most profit from discussion. The conversational agent system 106 takes advantage of multi-modal forms of interaction via speech, pointing and other types of gesture to further enhance the feeling of interacting with a facilitator as opposed to an analytical tool.

For example, the set of decision makers 104, through one or more of a text modality, a voice modality, and a gesture modality, provide input to the conversational agent system 106 such as, but not limited to, alternatives, the number of alternatives, features, alternative preferences, information retrieval queries, clarification/explanation queries and/or filter/selection queries. The conversational agent system 106, through one or more of a text modality, a voice modality, and a visual modality, provides output to the set of decision makers 104 such as, but not limited to, relevant information, current decision state, aggregate ranking, disagreement measure, subset of alternatives, subset of decision makers, discussion requests and/or clarification requests. As will be further explained, this iterative interaction between the decision makers 104 and the conversational agent system 106 yields a consensus decision 108.

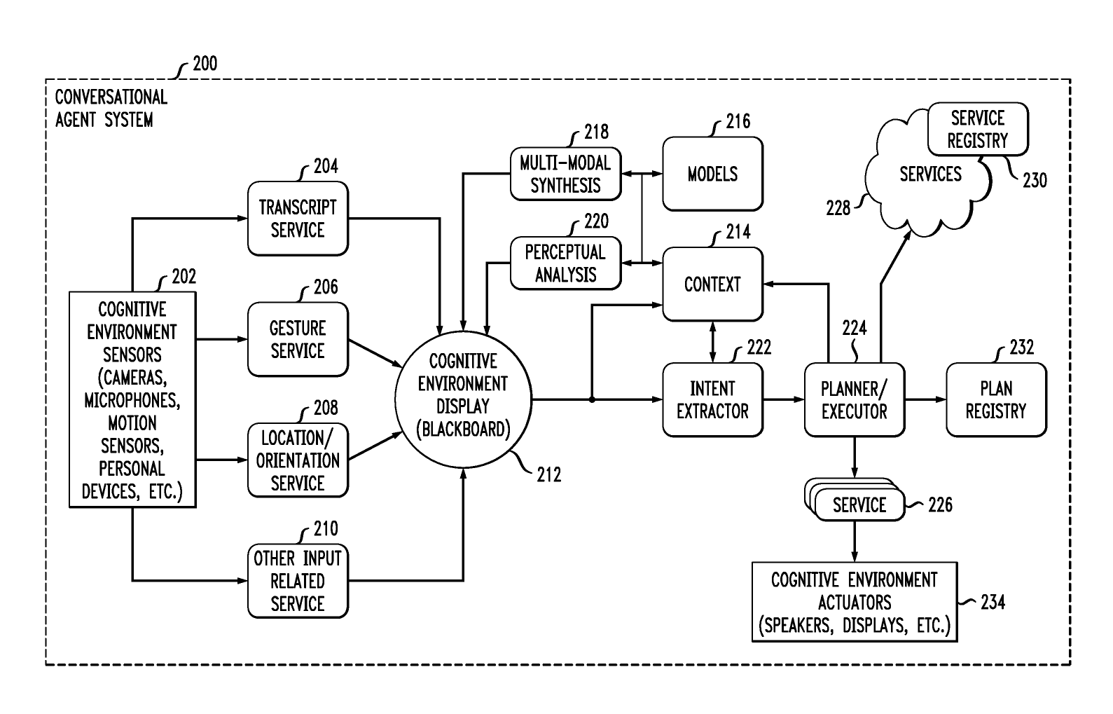

FIG. 2 depicts a block diagram illustrating a conversational agent system 200, according to an illustrative embodiment. It is to be appreciated that the conversational agent system 200 may represent one illustrative implementation of the conversational agent system 106 in FIG. 1. Other implementations are contemplated in alternative embodiments.

In one illustrative embodiment, the conversational agent system 200 can be implemented as part of an immersive environment that supports multimodal input and response, with access to rich audio, video, and sensory data about the subjects within the environment and the discussion itself. A non-limiting example of such an environment is the Cognitive Environment Laboratory (CEL) at Thomas J. Watson Research Center of IBM Corporation (Yorktown Heights, N.Y.). Illustrative embodiments leverage capabilities of such a cognitive environment in order to facilitate consensus amongst multiple decision makers. Other enabling software and hardware technologies that may be employed in an illustrative implementation of the conversational agent system 200 include modes and methods for feedback including text-based communication systems such as Slack, speech-to-text and text-to-speech capabilities that support voice-based communication, laptops, and other computing devices that allow the conversational agent system to interact with decision makers both privately (via chat) or publicly (via voice) in a room. However, it is to be appreciated that embodiments are not limited to any particular immersive or cognitive environment or to any particular modalities or interaction technologies.

As shown in FIG. 2, the conversational agent system 200 comprises a set of cognitive environment sensors 202. For example, the sensors 202 may comprise one or more cameras (for visual input), one or more microphones (for audio input), one or more motion sensors (for gesture input), one or more location/orientation sensors (for location/orientation input) and one or more personal devices (for textual or other input). Other sensors may be included as part of the set of sensors 202 depending on the input modalities employed by the decision makers 104.

Data from the various sensors is received, and converted by various sensor services into messages that are in a standard format (e.g., JavaScript Object Notation or JSON). The composition of the set of sensor services is dependent on the various modalities of the input data, i.e., there is a distinct data conversion service for each modality of input data. As shown in conversational agent system 200, a set of services comprises a transcript service 204, a gesture service 206, a location/orientation service 208, and other input related service(s) 210. The messages that are output by the various services 204-210 are published to a cognitive environment display 212. In one embodiment, the display 212 may comprise an electronic blackboard.

Higher-level services analyze and synthesize this raw data into higher-level representations of what is happening in the system, sometimes combining multiple modalities such as, for example, speech and gesture. Several iterations of processing may occur, in which a sensor analysis service (one of services 204-210) publishes its results to the blackboard 212, and these results are in turn used as input to another sensor analysis service. For example, these results (or at least some subset) are stored as context 214 and, along with models 216 (that collectively define the current state of the conversational agent system 200), are provided to one or more of the higher-level services shown as multi-modal synthesis 218 and perceptual analysis 220. These models and context are used by the analysis services 218 and 220 to perceptually interpret the input messages.

At some point, the sensor data has been analyzed and refined into a high-level description of what is happening in the environment that is essentially independent of that environment. An example of such a high-level description would be “Jeff just pointed at a representation of Mary Smith's resume and asked to see her reference letters.” Such a description represents a conclusion that comprises analyzing and fusing data from cameras, motion sensors, microphones, etc.

Furthermore, as shown in FIG. 2, an intent extractor 222 receives the high-level representation of what is happening in the system and attempts to determine what is desired by the people acting in that environment (in this case, the decision makers 104). Once this is determined, the necessary actions are determined by a planner/executor (e.g., rule-based engine) 224. These actions typically involve executing functions or calling services, i.e., local services 226 and/or cloud-based services 228 (managed in accordance with a service registry 230). “Local” refers to a service or component that is functionally co-located with one or more other services or components to form the conversational agent system 200 in the cognitive environment. Thus, the cloud-based services are one example of remote services (i.e., not local). The local and cloud-based services often require execution in a particular order which is defined in a plan registry 232. Among the services are some that cause content to be displayed on cognitive environment actuators 234 (e.g., a display and/or synthesized speech to be played through speakers in the environment) to the people in the environment (i.e., decision makers 104).

The conversational agent system 200 may be highly distributed. For example, in one or more illustrative embodiments, the various services and system depicted in FIG. 2 can be implemented on one physical or virtual machine. In other illustrative embodiments, the services and system are distributed across multiple physical or virtual machines.

It is to be appreciated that the architecture of the conversational agent system 200 in FIG. 2 is one example of a cognitive computing architecture that may be employed to implement the collective consensus decision making methodology according to one or more illustrative embodiments. Alternative cognitive computing architectures may be employed.

The methodology addresses a class of decisions in which a set of two or more individual decision makers wish to rank the top-k of a set of m>1 alternatives (where 1<=k>=m). For example, in general, the methodology: (i) accepts as input a list of decision alternatives; (ii) accepts as input the initial individual opinions of the desirability of the decision alternatives; (iii) analyzes the degree of consensus among the decision makers; (iv) if the degree of consensus is deemed sufficient, reports the near-consensus ranking and actively suggests that the collective decision process be terminated; (v) otherwise, if the collective decision process is not to be terminated, actively suggests to the decision makers a set of one or more discussions in which they should engage, and for each of those discussions which alternatives should be discussed and which of the decision makers should participate in the discussion; (vi) interacts with human decision makers to monitor and guide the discussion in a manner most likely to result in modification of the individual rankings of the alternatives; and (vii) determines or suggests when the discussions are finished, and when all are finished returns to step (i).

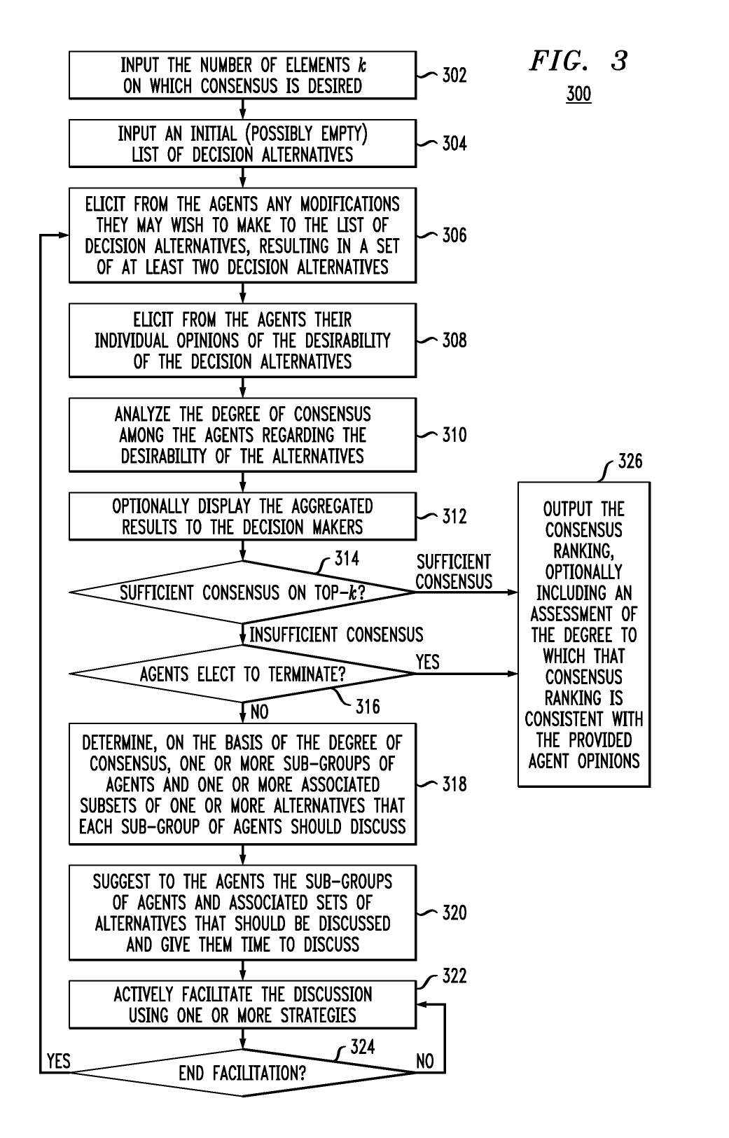

FIG. 3 illustrates a methodology 300 for collective decision making by consensus in a cognitive environment, according to an illustrative embodiment. That is, FIG. 3 depicts an illustrative set of steps that implement the above-mentioned process flow. While the consensus decision process is not limited to any specific setting, illustrative reference will be made below to a non-limiting job hiring example and/or a mergers and acquisitions example.

Let V={vl, . . . , vn} be a finite set of decision makers (voters) with |V|=n and A={cl, . . . , cm} be a finite set of alternatives with |A|=m. It is assumed that each voter has an underlying complete, strict linear order [symbol] vi that they can report to the system. The task of the conversational agent system is defined as the “top-k consensus ranking task.” As the setting is a meeting/close personal environment, a goal may be to achieve a consensus (unanimous) ranking (or ϵ-close to the consensus ranking) on the top-k candidates. Note that when k=1 this is the regular single winner setting, and when k=m this is the traditional rank aggregation setting.

The conversational agent system 200 (106 in FIG. 1) performs this data driven process as shown in the steps of methodology 300 of FIG. 3. Steps 302-326 will now be described in detail below, along with some non-limiting examples of algorithms for performing certain of the steps.

Step 302: Input the number of elements k on which consensus is desired.

This number can be agreed on a priori or it can be input to the task by the chair or some other administrator for the decision. Often this will be task dependent, i.e., one winner for a contest is needed or a rank order is needed (e.g., a ranked list of acquisition targets).

Step 304: Input the initial (possibly empty) list of decision alternatives.

This list can be a priming list that comes from any number of sources including one of the decision makers acting as a chair, candidates who have submitted job applications, data from a website or other location, information gleaned for documents, etc.

Step 306: Elicit from the decision makers any modifications (e.g., additions or deletions) they may wish to make to the list of decision alternatives, resulting in a set of at least two decision alternatives.

This information can be provided through any number of modalities including vocally and on a laptop of a decision maker.

This step could amount to prescreening in a job hiring example or dismissing of companies who are too expensive in a mergers and acquisitions setting.

Step 308: Elicit from the decision makers their individual opinions of the desirability of the decision alternatives.

This input can be provided through any number of modalities including vocally, gesture, or on a laptop of a decision maker.

The opinions of the decision makers can be submitted in any number of standard preference formats, e.g., strict linear orders over the candidates, approval votes, disapproval votes, weak orders, CP-nets, constraints, utilities, bids, bids over bundles of candidates, etc. For a more comprehensive list of preference formats see, e.g., PrefLib: A Library for Preferences. Nicholas Mattei and Toby Walsh. International Conference on Algorithmic Decision Theory (ADT 2013), November 2013.

Step 310: Analyze the degree of consensus among the decision makers regarding the desirability of the alternatives.

In one embodiment, the degree of consensus is determined by declaring consensus if all decision makers agree completely, i.e. unanimity, and declaring no consensus otherwise.

In another embodiment, the degree of consensus is determined by defining a relaxation of unanimity with respect to the top-k candidates to some threshold or ϵ-unanimity. Using this ϵ-unanimity over the top-k candidates as a stopping condition is motivated by having buy-in from all the decision makers and the reality that sometimes full consensus is not achievable. One way of measuring c-unanimity is by a count of the number of decision makers who do not have the same opinions. So, for example, if ϵ=1 then unanimity is needed for all decision makers but one. Unanimity could also be measured by other axes including a fraction of the overall number of decision makers that agree with the consensus or the distance of the input preferences from the final ordering according to a suitable distance metric.

In yet another embodiment, the degree of consensus is determined by taking the result of the Kemeny voting rule, which is the ranking r that minimizes the Kemeny Score, i.e., the sum of the Kendall-Tau distance between the opinion of each decision maker and r. Thus, another stopping condition could be a Kemeny Score below a certain threshold.

Step 312: Optionally display the aggregated results to the decision makers.

The aggregated results can be computed using a number of different voting methods including, but not limited to, Scoring Rules, Borda, Copeland, Ranked Pairs, etc. More voting rules can be found in Handbook of Computational Social Choice. F. Brandt, V. Conitzer, U. Endriss, J. Lang, and A. D. Procaccia, editors. Cambridge University Press, 2016.

The modality of the display can take various forms such as a large screen display, on individual laptops of decision makers, announcement in a Slack channel, voice, etc.

Step 314: Determine, on the basis of the degree of consensus about the top-k, whether to terminate the collective decision process.

If there is sufficient consensus, proceed to Step 326.

If not, proceed to Step 316.

Step 316: Optionally, display a visualization of the analysis of Step 310 to the decision makers, and allowing them (or the decision chair) to decide whether or not to terminate the collective decision process.

If they decide to terminate, proceed to Step 326.

Otherwise, proceed to Step 318.

Step 318: Determine, on the basis of the degree of consensus, one or more sub-groups of decision makers and one or more associated subsets of one or more alternatives that each sub-group of decision makers should discuss.

Determining the degree of consensus may be performed from two perspectives: that of the decision alternatives, e.g., the degree of consensus for each alternative across the set of decision makers, and that of the decision makers, e.g., identifying sub-groups of decision makers that most agree (or possibly disagree) with one another across the set of alternatives. The analysis may even be a mixture of the two, i.e., identifying subgroups of decision makers and associated subsets of decision alternatives about which they most agree or disagree.

One method by which the system can identify groups that agree is the following: the system first clusters the decision makers into groupings based on the Kendall-Tau distance between the clusters. More formally, the Kendall-Tau distance is a distance between any two strict linear orders. This distance metric is used to partition the set of decision makers into those that are close together and those that are far apart using k-means clustering. The subgroups of people who should discuss in Step 320 are these clusters.

One method for the system to identify groups of individuals that disagree is to combine pairs of agreement clusters that are maximally distant.

One method the system can use to identify alternatives that are causing dissent either across the group as a whole or within an identified subgroup is the following: the system can run the Condorcet or Ranked Pairs rule and use the pair scores of the alternatives to find the alternatives on which there is maximal disagreement. The pair score between alternatives a and b is defined as |{i∈V: a [symbol] vi b}−{i∈V: b [symbol] vi a}|. The sets of alternatives that should be discussed by the decision makers in Step 320 are those with low pair scores.

Step 320: Suggest to the decision makers the sub-groups of decision makers and associated sets of alternatives that should be discussed and give them time to discuss. After a period of time, or under appropriate conditions, return to Step 308.

One method the system may employ is, using the k-means groups identified in Step 318, encouraging sets of decision makers that are near each other (have low tau between the decision makers in this cluster) to discuss, then the system asks groups with larger differences in their tau's to discuss.

One method the system may employ is, using the pair scores of the alternatives determined in Step 318, for each subset of alternatives where the pair score is not n, from least to most, the system prompts all the decision makers present to discuss and consider the elements of the pair.

Another method the system may use is a combination of the above two methods whereby subsets of alternatives are discussed by subsets of the identified groups; possibly interleaving and merging groups as discussion proceeds.

The suggestions by the system may take a variety of forms including, but not limited to: using text and/or speech synthesis to suggest the sub-groups of decision makers and associated subsets of alternatives to be discussed by each, plus instructions that allow the decision makers to move back to Step 306.

Step 322: Actively facilitate the discussion process, e.g., by doing any or all of the following:

Setting up communication channels such as chat, Slack, etc.

Providing factual information relating to the alternatives under discussion.

Leading the sub-groups through a series of questions aimed at helping the decision makers explain, explore and re-evaluate their assessments of desirability of the various alternatives, such as which attributes are most important.

Summarizing the current state of the decision and pertinent discussion.

Suggesting a reduced set of decision alternatives and/or decision criteria extracted from the facilitated discussion.

Step 324. Determine when to end the facilitated discussion, and upon that determination return to Step 306. If it is determined not to end the facilitated discussion, then return to step 322.

Step 326: Output the consensus ranking, optionally including an assessment of the degree to which that consensus ranking is consistent with the provided decision makers' opinions.

In an alternative embodiment, the elicitation of alternatives (Step 306) and the desirability (Step 308) of the alternatives may be performed differently from one iteration to the next, depending upon context. For example, during the initial elicitation in Step 308, the system may simply ask for a rating or ranking of the alternatives, and it may only require that each decision maker provide ratings or rankings for at least two of the alternatives (not necessarily the whole list). However, during subsequent iterations, the system may explicitly require ratings or rankings for an explicit subset of the m alternatives, or even require that each decision maker provide more detailed information about the desirability of each alternative, such as a score for each alternative for each of a set of attributes that has been derived from the discussion engendered by Step 322.

In an alternative embodiment, the facilitation of the discussion of Step 322 can be followed by facilitation of a discussion among all of the decision makers, in which the various techniques of Step 322 would be applied within the group as a whole to enable some further resolution of their differences. The decision makers can focus their attention on where their chief differences lie by providing some visualization of the current state of the decision, including the attributes and preferences derived during the sub-group discussions.

As a specific illustrative example, consider application of one or more illustrative embodiments to a situation in which multiple decision makers are deliberating over which of several candidates to hire for a job position. Suppose that the decision makers are sitting together in a room that is equipped with devices such as cameras and microphones that allow the conversational agent system to see and hear them, plus a speaker and a display through which the conversational agent system can communicate with the decision makers. Assume further that decision makers can use some means such as an attention word (such as a name given to the conversational agent system, such as, e.g., “Pat”) or looking at a visual representation of that conversational agent system (e.g., an avatar) to indicate that they are addressing the conversational agent system, as opposed to another one of the decision makers. The decision session could be initiated by one of the decision makers requesting it verbally, e.g., by saying “Pat, we want to start a decision session on hiring.” A possible interaction sequence consistent with one or more illustrative embodiments would then be as follows (note that Human1/H1, Human2/H2, and so on, are the decision makers, and that the steps of methodology 300 are referenced where appropriate):

Human1. Pat, please start a decision session on hiring.

Pat. OK. How many candidates do you want to hire? (Eliciting k, step 302.)

Human1. We just want to hire a single candidate. (k is set to 1)

Pat. OK. Please input the list of candidates you are considering for hire. (Eliciting an initial set of decision alternatives, step 302.)

Human2. Pat, please look up the set of candidates who applied for job requisition 654321, and consider that as our list of candidates.

Pat. OK. Here are the 12 candidates I found. (Lists their names on the display.) Would you like to modify this list in any way? (Elicit from the agents any modifications they might want to make, step 306.).

Human3. (To the other decision makers) I think we should make sure that the candidates have at least 2 years of relevant experience; don't you?

Humans 1, 2, and 4. Sure. Yup. Yes, that makes sense.

Human3. Pat, let's just consider candidates with at least 2 years of experience in copying illuminated manuscripts.

Pat. OK, here are the 8 candidates that satisfy your criteria. (Lists their names on the display.) Pat causes a preference elicitation graphical user interface (GUI) to be displayed to Humans 1, 2, 3 and 4 on their individual devices.

Pat. Everyone, now I need to know your preferences. Please use the preference elicitation GUI that I've brought up on your individual displays and hit the submit button when you're finished. (Elicit from the agents their individual preferences, step 308).

After a minute or two, everyone has entered their initial rankings of the candidates.

Pat computes the aggregate ranking and the degree of consensus (step 310), and finds that the degree of consensus is not sufficiently great, i.e., additional work is needed to reach a sufficient consensus.

Pat. Thanks to all of you for submitting your preferences. You still have some work to do before you have reached sufficient agreement. Here is a brief analysis of my findings.

Pat displays a visualization of the aggregate rankings and the disagreement among Humans 1, 2, 3 and 4. (Step 312.)

Pat. As you can see from the aggregate rankings, you strongly agree that the top 4 candidates are Allison, Bartleby, Garrett and Ida. We can clearly eliminate Desiree, Egbert, Franklin and Hannah from further consideration. However, as you can see from the disagreement analysis, you moderately disagree with one another about these top 4. I recommend that we do some more work to resolve who is the top candidate. (Step 314)

Pat. I can help you with that. Would you like to continue? (Step 316)

H1, 2, 3, 4. Yes please, Pat.

Pat. OK, good. (Takes a moment to compute suggested discussion sub-groups and topics—Step 318.)

Pat. I suggest that H1 and H4 discuss their relative rankings of Allison and Bartleby, and H2 and H3 discuss their relative rankings of Garrett and Ida. (Steps 318 and 320).

H4 gets up and sits next to H1, and H3 gets up and sits next to H2.

Pat (to H1 and H4). Both of you strongly preferred Bartleby to Allison. Could you each describe some of the attributes that you like most about Bartleby? (Step 322.)

H1. I saw Bartleby's handwriting, and it was beautiful.

H4. And I like that he was a street artist for a few years.

Pat. OK. And why don't you like Allison?

H1. The handwriting on her application was not the best.

H4. And I don't see any evidence that she has done much artwork.

Pat. OK. So it sounds like the attributes you find most important are a) handwriting and b) artistry. And Bartleby is superior to Allison in both of those attributes. Is that correct? H1 and H4. Yes.

Pat. Are there any other important attributes you want to mention?

H1 and H4. No, that's all.

Pat. OK, thank you—I'll get back to you in a minute.

Pat (to H2 and H3, in parallel with conversation with H1 and H4). Both of you strongly preferred Garrett to Ida. Could you each describe some of the attributes that you like most about Garrett?

H2. I was impressed with his reading speed—150 words per minute!

H3. Yes, I agree—that is what struck me about Garrett.

Pat. OK. And why don't you like Ida?

H2. I'm not sure—her resume seemed somewhat uninspiring to me.

H3. Yeah, I just skimmed it and agree.

Pat. OK. So it sounds like the attribute that is most important is reading speed. Is that correct?

H2 and H3. Yes.

Pat. But I have not captured an opinion from you about Ida's reading speed. Can you confirm that Garrett's reading speed is superior to Ida's?

H2. Umm, well actually I'm not sure.

H3. Gee, I don't know.

Pat. OK, let me see if I can find some information about Ida. Here is her resume (displays it to H2 and H3). I've highlighted in yellow some passages that appear to be about reading.

H2. (Scrolling through the resume). Hmmm, I don't see a reading speed here, but look at this: Ida says she once read the unabridged version of Herman Melville's “Moby Dick” in a single sitting. Wow.

H3. I missed that when I looked at her resume the first time. That's quite impressive!

H2. Yeah. Maybe we should actually rate Ida above Garrett.

H3. Yes, I agree. Pat, we prefer Ida to Garrett now.

Pat. OK, thank you.

Pat (to H1, H2, H3 and H4). OK, thanks to all of you for our recent discussion. Here is a summary of my findings. It appears that the attributes that are most important to all of you are: a) years of relevant experience; b) handwriting, c) artistry, and d) reading speed. Here is a partial table of results:

Pat shows a table listing these three attributes on the rows, and a partial ordering of candidates based on the initial filter query and the two discussions.

Pat. I suggest that you have some further discussion amongst yourselves about how Allison, Bartleby, Garrett and Ida rate along these three attributes. While you're having this discussion, feel free to ask me to retrieve resumes, references or other information. When each of you have made up your mind and feel that you're ready to re-enter your rankings, hit the Ready button.

Several minutes go by, and a lively discussion ensues, which entails some further queries and other interactions with Pat. Eventually, all 4 decision makers are ready, and indicate that they are ready.

Pat. OK everyone, now I need to know your preferences. Please use the preference elicitation GUI that I've brought up on your individual displays. Note that the choices are limited to the four remaining candidates. Click the submit button when you're finished. (Elicit from the decision makers their individual preferences, step 308.).

After a minute or two, everyone has entered their rankings of the candidates.

Pat computes the aggregate ranking and the degree of consensus (step 310), and finds that the degree of consensus is sufficient.

Pat. Thanks to all of you for submitting your preferences. You are now in strong agreement that Ida is the best candidate: three of you have her as #1, and one of you selected her as #2. (Step 314.) Here is a brief analysis of my findings.

Pat displays a visualization of the aggregate rankings and the (now minor) disagreement among Humans 1, 2, 3 and 4(Step 326.).

Pat. Please confirm that you are satisfied with this result.

H1, H2, H3 and H4. Yes—thanks very much, Pat. Goodbye for now.

Pat. You're welcome. Have a nice day.

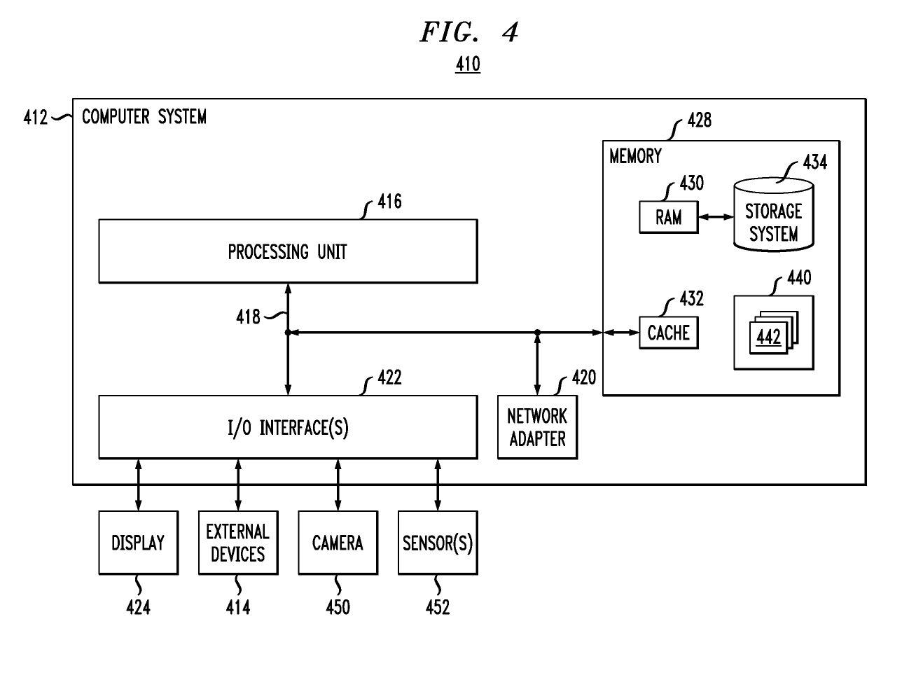

One or more embodiments can make use of software running on a computer or workstation. With reference to FIG. 4, in a computing node 410 there is a system/server 412, which is operational with numerous other general purpose or special purpose computing system environments or configurations. Examples of well-known computing systems, environments, and/or configurations that may be suitable for use with system/server 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

System/server 412 may be described in the general context of computer system executable instructions, such as program modules, being executed by a computer system. Generally, program modules may include routines, programs, objects, components, logic, data structures, and so on that perform particular tasks or implement particular abstract data types. System/server 412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, system/server 412 is shown in the form of a computing device. The components of system/server 412 may include, but are not limited to, one or more processors or processing units 416, system memory 428, and bus 418 that couples various system components including system memory 428 to processor 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

System/server 412 typically includes a variety of computer system readable media. Such media may be any available media that is accessible by system/server 412, and it includes both volatile and non-volatile media, removable and non-removable media.

The system memory 428 can include computer system readable media in the form of volatile memory, such as random access memory (RAM) 430 and/or cache memory 432. System/server 412 may further include other removable/non-removable, volatile/nonvolatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces.

As depicted and described herein, memory 428 may include at least one program product having a set (e.g., at least one) of program modules that are configured to carry out the functions of embodiments of the invention. A program/utility 440, having a set (at least one) of program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein.

System/server 412 may also communicate with one or more external devices 414 such as a keyboard, a pointing device, an external data storage device (e.g., a USB drive), display 424, camera 450, sensor(s) 452, one or more devices that enable a user to interact with system/server 412, and/or any devices (e.g., network card, modem, etc.) that enable system/server 412 to communicate with one or more other computing devices. In one embodiment, camera 450 is configured to capture an image of one or more bidders from an auction, and generate a list of the one or more bidders by processing the image. In one embodiment, sensor(s) 452 are configured to obtain data associated with the auction. For example, sensor(s) 452 may be configured to obtain physiological data and current weather, as described with reference to FIG. 2. Such communication can occur via I/O interfaces 422. Still yet, system/server 412 can communicate with one or more networks such as a LAN, a general WAN, and/or a public network (e.g., the Internet) via network adapter 420. As depicted, network adapter 420 communicates with the other components of system/server 412 via bus 418. It should be understood that although not shown, other hardware and/or software components could be used in conjunction with system/server 412. Examples include, but are not limited to, microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

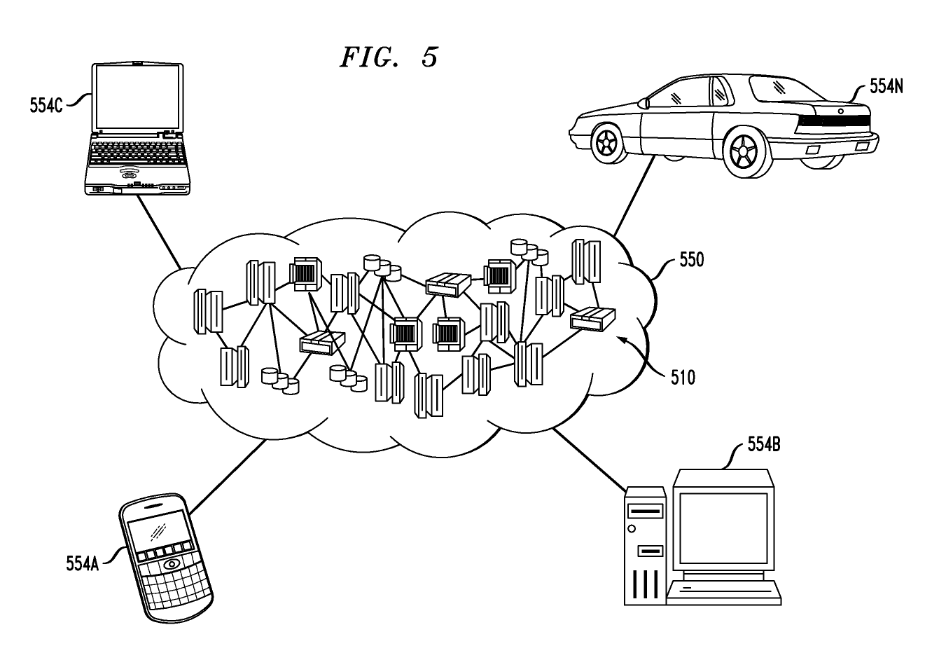

Referring now to FIG. 5, illustrative cloud computing environment 550 is depicted. As shown, cloud computing environment 550 includes one or more cloud computing nodes 510 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

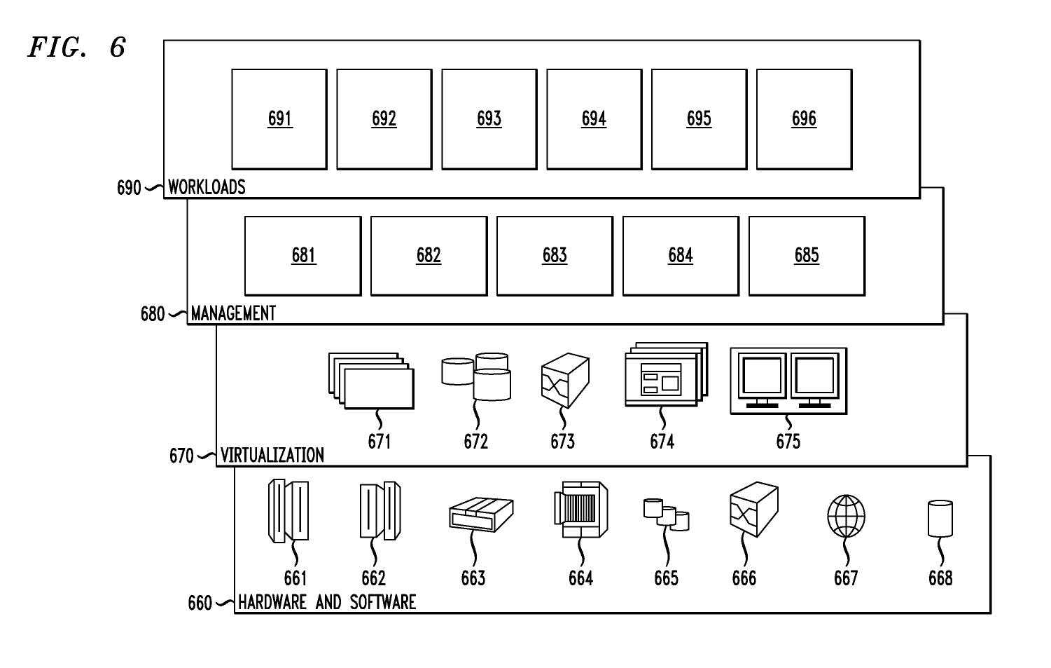

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and vicinity based cognitive bidding support 696, which may perform various functions described above.

The embodiments described herein advantageously provide for vicinity based bidding support during an auction using cognitive modeling techniques. For example, the embodiments described herein advantageously leverage data obtained from various sources, such as social media, sensor data, and other external data sources, in order to optimize bidding strategy during an auction by collecting and interpreting data that may impact bidding strategy during the auction (e.g., data related to the bidder(s), the auction item(s), etc.). An alert may be generated to a user in real-time, or near real-time, based on output generated from an analysis of the obtained data, in order to suggest or recommend a particular bidding strategy. Advantageously, the analysis comprises utilizing cognitive modeling techniques to generate and implement one or more cognitive models. The embodiments described herein can allow for an adjustment of the one or more cognitive models, in real-time or near real-time, based on one or more observations made during the auction, such as feedback obtained in response to a success or failure in predicting a given bidder's bidding behavior.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A system comprising:
one or more memory devices; and
one or more processor devices operatively coupled to the one or more memory devices and configured to automatically facilitate a decision process to enable a set of decision makers to reach a decision that represents consensus or near-consensus among the decision makers, the one or more processor devices executing steps comprising:
obtaining input representing a set of decision alternatives;
obtaining input from the decision makers representing indicators of desirability corresponding to the decision alternatives;
analyzing a degree of consensus among the decision makers in accordance with the desirability indicators obtained;
in response to the degree of consensus being deemed sufficient, reporting the decision to the decision makers;
in response to the degree of consensus being deemed insufficient, actively suggesting to the decision makers a set of one or more discussions in which they should engage, and for each of those discussions which decision alternatives should be discussed and which of the decision makers should participate in the discussion; and
interacting with the decision makers to facilitate the discussion in order to obtain a degree of consensus that is deemed sufficient.

2. The system of claim 1, wherein the one or more processor devices execute a step of presenting to the decision makers the decision as a ranked list of the decision alternatives.

3. The system of claim 1, wherein the step of analyzing the degree of consensus comprises measuring the degree of consensus for each decision alternative across the set of decision makers.

4. The system of claim 1, wherein the step of analyzing the degree of consensus comprises identifying sub-groups of decision makers that most agree with one another across the set of decision alternatives.

5. The system of claim 1, wherein the one or more processor devices execute a step of facilitating termination of the decision process by comparing the analysis of the degree of consensus to at least one pre-determined threshold.

6. The system of claim 5, wherein the step of facilitating termination of the decision process further comprises presenting to the decision makers a visualization of the analysis of the degree of consensus, and providing an interface by which the decision makers can determine whether the decision process is to be terminated.

7. The system of claim 1, wherein the step of actively suggesting comprises using at least one of text messages and speech synthesis to suggest the sub-groups of decision makers and associated subsets of decision alternatives to be discussed.

8. The system of claim 1, wherein the step of actively suggesting comprises actively facilitating the discussion between the decision makers.

9. The system of claim 8, wherein the step of actively facilitating the discussion comprises setting up communication channels among decision makers belonging to the identified sub-groups.

10. The system of claim 8, wherein the step of actively facilitating the discussion comprises providing factual information relating to the decision alternatives under discussion.

11. The system of claim 8, wherein the step of actively facilitating the discussion comprises leading the sub-groups through a series of questions designed to help the decision makers re-evaluate their assessments of desirability of the various decision alternatives.

12. The system of claim 1, wherein the step of obtaining the desirability of the decision alternatives comprises querying each decision maker for a rating of at least two of the decision alternatives.

13. The system of claim 1, wherein the step of obtaining the desirability of the decision alternatives comprises querying each decision maker for a rating of a specified subset of the full set of decision alternatives.

14. The system of claim 1, wherein the step of obtaining the desirability of the decision alternatives comprises querying each decision maker to evaluate each member of a specified subset of the full set of decision alternatives along a specified set of attributes.

15. The system of claim 1, wherein the decision process is terminated when a measured unanimity parameter is less than or equal to a pre-determined threshold value.

16. The system of claim 5, wherein the step of determining the sub-groups of agents and their associated subsets of decision alternatives comprises:
applying a Kendall-Tau analysis to determine sub-groups of similarly-minded decision makers; and
within each sub-group of decision makers, identifying subsets of decision alternatives for which there is high agreement or disagreement using one of a Condorcet and Ranked pairs analysis.

17. The system of claim 2, wherein the step of presenting the decision further comprises outputting an assessment of the degree to which that consensus is consistent with provided decision maker preferences.

18. The system of claim 1, wherein the step of obtaining input representing the set of decision alternatives comprises actively eliciting from the decision makers a list of decision alternatives.

19. A method comprising:
in a system comprising one or more processor devices operatively coupled to one or more memory devices and configured to automatically facilitate a decision process to enable a set of decision makers to reach a decision that represents consensus or near-consensus among the decision makers, the one or more processor devices executing steps comprising:
obtaining input representing a set of decision alternatives;
obtaining input from the decision makers representing indicators of desirability corresponding to the decision alternatives;
analyzing a degree of consensus among the decision makers in accordance with the desirability indicators obtained;
in response to the degree of consensus being deemed sufficient, reporting the decision to the decision makers;
in response to the degree of consensus being deemed insufficient, actively suggesting to the decision makers a set of one or more discussions in which they should engage, and for each of those discussions which decision alternatives should be discussed and which of the decision makers should participate in the discussion; and
interacting with the decision makers to facilitate the discussion in order to obtain a degree of consensus that is deemed sufficient.

20. An article of manufacture comprising a processor-readable storage medium having encoded therein executable code of one or more software programs, wherein the one or more software programs when executed cause one or more processor devices operatively coupled to one or more memory devices to automatically facilitate a decision process to enable a set of decision makers to reach a decision that represents consensus or near-consensus among the decision makers, wherein the facilitated decision process comprises:
obtaining input representing a set of decision alternatives;
obtaining input from the decision makers representing indicators of desirability corresponding to the decision alternatives;
analyzing a degree of consensus among the decision makers in accordance with the desirability indicators obtained;
in response to the degree of consensus being deemed sufficient, reporting the decision to the decision makers;
in response to the degree of consensus being deemed insufficient, actively suggesting to the decision makers a set of one or more discussions in which they should engage, and for each of those discussions which decision alternatives should be discussed and which of the decision makers should participate in the discussion; and
interacting with the decision makers to facilitate the discussion in order to obtain a degree of consensus that is deemed sufficient.
